(19) United States
(12) Patent Application Publication
(10) Pub. No.: US 2010/0158098 A1
(43) Pub. Date: Jun. 24, 2010

(54) SYSTEM AND METHOD FOR AUDIO/VIDEO CONTENT TRANSCODING

(75) Inventors: Jeffrey Lang McSchooler, Cheyenne, WY (US); Paul J. Bellotti, Cheyenne, WY (US)

Correspondence Address: SETTER ROCHE LLP, PO BOX 780, ERIE, CO, 80516, US

(73) Assignee: EchoStar Technologies L.L.C., Englewood, CO (US)

(21) Appl. No.: 12/341,727

(22) Filed: Dec. 22, 2008

(51) Int. Cl. H04N 7/12; G06F 17/30

(52) U.S. Cl. 375/240.01; 707/E17.002

(57) ABSTRACT

A method for transcoding audio/video content is presented. In the method, a first digital file including the audio/video content is received and stored. Audio/video attributes for generating a second digital file including the audio/video content of the first digital file are also received. The stored first digital file is then transcoded based on the audio/video attributes to generate the second digital file. The second digital file is then stored and transferred for presentation to a user.

### BACKGROUND

The existence of at least dozens of television broadcast channels delivered by satellite and cable television broadcast networks represents a vast number of audio/video outlets by which a user may view a particular item of audio/video content, such as a motion picture, weekly entertainment show, newscast, or sporting event. In addition, much of this same audio/video content is often accessible by non-broadcast means, such as by way of computer, portable video player, mobile phone, and the like, via a communication network, such as the Internet.

To make available a particular item of content to users, a content provider, such as a television network, or a cable or satellite network operator, often requests the content from a source of the content, such as the copyright holder or owner, presuming the content provider has procured the rights to broadcast or otherwise distribute the content. The request is normally accompanied by desired attributes specifying particular elements of the format of the content, such as standard definition (SD) versus high definition (HD) video resolution, widescreen versus letterbox versus full-screen video format, monaural versus Dolby® Digital AC3 2.0 versus AC3 5.1 audio format, and even the desired length of the content. In response, the source typically causes a digital tape of the requested content conforming to the requested attributes to be delivered to the content provider.

After receiving the digital tape, the content provider reviews the tape to ensure conformance to the requested attributes. Presuming the tape is acceptable, the content provider then “ingests” the tape by converting the stream of content on the tape to a digital file possessing additional attributes selected by the provider, such as Motion Picture Experts Group (MPEG)-2 versus MPEG-4 encoding, lower versus higher video resolution, and the like, that allow a particular target user device, whether a television, set-top box, computer, mobile phone, or other component, to display the content to a user.

Oftentimes, more than one such digital file is generated from the received tape so that the content may be accessed through a variety of user devices. For example, in the case of mobile phones and similar communication components, the content may be presented in a compressed, reduced-resolution format more suitable for that device than what would normally be delivered to a television. Also, each device may be capable of presenting the audio/video content in a format selected from a number of different formats by the user, each offering a particular tradeoff between various factors, such as communication bandwidth, video resolution, and other audio/video attributes.

Generally, an agreement between the source of the content and the service provider stipulates that the content provider destroy the digital tape and any digital files generated therefrom after a specific period of time to reduce the possibility that the content becomes accessible to a party not authorized to access the associated content.

### BRIEF DESCRIPTION OF THE DRAWINGS

Many aspects of the present disclosure may be better understood with reference to the following drawings. The components in the drawings are not necessarily depicted to scale, as emphasis is instead placed upon clear illustration of the principles of the disclosure. Moreover, in the drawings, like reference numerals designate corresponding parts throughout the several views. Also, while several embodiments are described in connection with these drawings, the disclosure is not limited to the embodiments disclosed herein. On the contrary, the intent is to cover all alternatives, modifications, and equivalents.

FIG. 1 is a block diagram of an audio/video processing system according to an embodiment of the invention.

FIG. 2 is a flow diagram of a method for transcoding audio/video content according to an embodiment of the invention.

FIG. 3 is a block diagram of an audio/video processing system according to another embodiment of the invention.

FIG. 4 is a data transfer diagram involving the audio/video processing system of FIG. 3 according to another embodiment of the invention.

### DETAILED DESCRIPTION

The enclosed drawings and the following description depict specific embodiments of the invention to teach those skilled in the art how to make and use the best mode of the invention. For the purpose of teaching inventive principles, some conventional aspects have been simplified or omitted. Those skilled in the art will appreciate variations of these embodiments that fall within the scope of the invention. Those skilled in the art will also appreciate that the features described below can be combined in various ways to form multiple embodiments of the invention. As a result, the invention is not limited to the specific embodiments described below, but only by the claims and their equivalents.

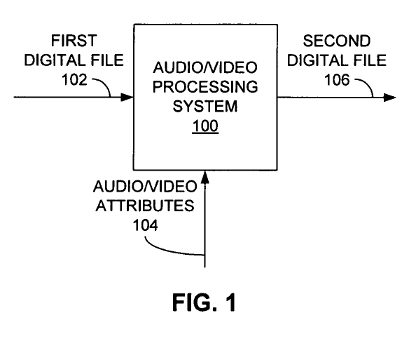

FIG. 1 is a simplified block diagram of an audio/video processing system 100 according to an embodiment of the invention. Herein, audio/video content may include video or other visual content only, audio content only, or both video/visual and related audio content. Further, the audio/video content may include one or more audio/video programs, such as movies, sporting events, newscasts, television episodes, and other programs, or a portion thereof. The audio/video processing system 100 may include one or more separate electronic components or systems, or be incorporated within one or more other electronic components or systems.

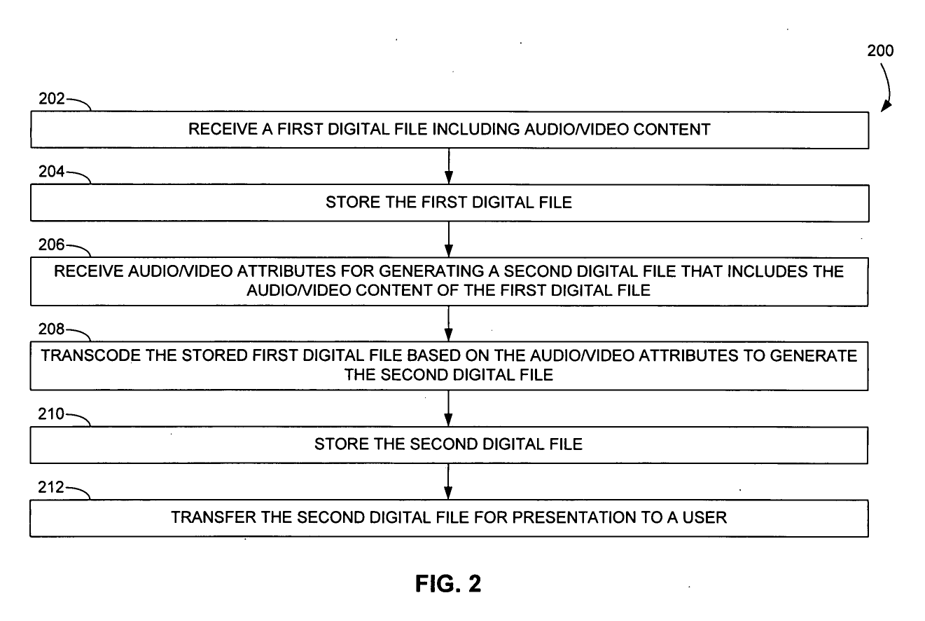

FIG. 2 presents a flow diagram of a method of transcoding audio/video content according to an embodiment of the invention using the audio/video processing system 100 of FIG. 1. While the processing system 100 of FIG. 1 is employed as the platform for carrying out the method 200, aspects of the method 200 may be utilized in conjunction with other audio/video processing systems not specifically discussed herein.

In the method 200, a first digital file 102 including audio/video content is received at the audio/video processing system 100 (operation 202), which stores the first digital file 102 (operation 204). The processing system 100 also receives audio/video attributes 104 for generating a second digital file 106 that includes the audio/video content of the first digital file 102 (operation 206). The audio/video processing system 100 transcodes the stored first digital file 102 based on the audio/video attributes 104 to generate the second digital file 106 (operation 208).

Transcoding may be any translation from the first digital file 102 of audio/video content to the second digital file 106 representing the same content. For example, transcoding may involve altering any of the technical specifications of the first digital file 102 to be stored as the second digital file 106. Examples of various attributes, such as those attributes 104 mentioned above, include the audio/video encoding format (such as MPEG-2 or MPEG-4), the resolution of the video (such as SD or HD), the form factor of the video (such as widescreen, letterbox, or fullscreen), the image size of the video (often cited in terms of numbers of picture elements (pixels) in both the vertical and horizontal directions), audio channel encoding format (such as monaural versus AC3 2.0 versus AC3 5.1), and others not specifically described herein.

The audio/video processing system 100 stores the generated second digital file 106 (operation 210) and transfers the second digital file 106 for presentation to at least one user (operation 212). While FIG. 2 indicates a specific order of execution of the operations 202-212, other possible orders of execution, including concurrent execution of one or more operations, may be undertaken in other implementations. In another embodiment, a computer-readable storage medium may have encoded thereon instructions for one or more processors or other control logic to direct the processor to implement the method 200.

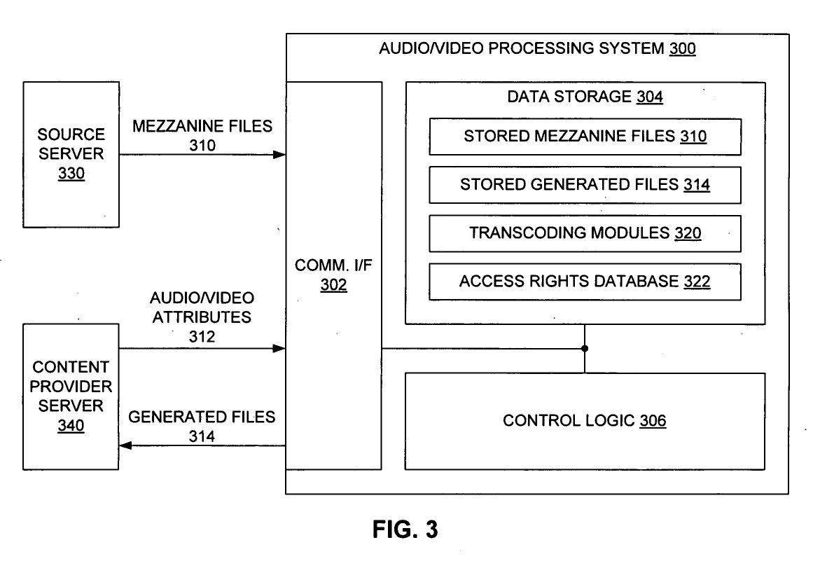

FIG. 3 presents a block diagram of another audio/video processing system 300 including a communication interface 302, data storage 304, and control logic 306. The communication interface 302 may be any communication interface facilitating the transfer of digital files and other data to and from the audio/video processing system 300. For example, the communication interface 302 may include one or more of an IP network interface (such as a digital subscriber line (DSL), cable, or other connection to the Internet, other wide area network (WAN) or local area network (LAN)), a Multiprotocol Label Switching (MPLS) network interface, or an Asynchronous Transfer Mode (ATM) network interface. In other embodiments, the communication interface 302 may include an interface for a satellite communication network, a cable communication network, an optical communication network, or another communication network employing another wired or wireless communication technology.

The data storage 304 of the audio/video processing system 300 may include any data storage components and/or media capable of storing the digital files and associated data to be discussed in greater detail below. Examples of the data storage 304 include, but are not limited to, static random access memory (SRAM), dynamic random access memory (DRAM), flash memory, or any other integrated circuit (IC) based memory. In another implementation, the data storage 304 may include disk based storage, such as magnetic hard disk drive storage or optical disk drive storage, as well as other types of primary or secondary data storage.

Generally, the control logic 306 of the processing system 300 is configured to process the data of the digital files discussed below, and to control the communication interface 302 and the data storage 304, as well other aspects of the processing system 300 not specifically described herein. The control logic 306 may include any control circuitry capable of performing the various tasks described below in conjunction with the processing system 300. For example, the control logic 306 may be a processor, such as a microprocessor, microcontroller, or digital signal processor (DSP), configured to execute instructions directing the processor to perform the functions discussed in detail below. In another implementation, the control logic 306 may be hardware-based logic, or may include a combination of hardware, firmware, and/or software elements.

Generally, the audio/video processing system 300 facilitates the transcoding or reformatting of audio/video content or information provided by a first digital file 310 to generate a second digital file 314 containing audio/video content in a format employable by at least one device to present the content to a user. Such devices may include, but are not limited to, televisions and video monitors, set-top boxes, audio receivers, computers, portable audio/video players, personal digital assistants (PDAs), and mobile phones.

In the specific example of FIG. 3, the first digital file 310 is referred to as a “mezzanine file” 310, which is a high-quality, high-data-rate digital file containing, describing, or otherwise representing an item of audio/video or audio/visual content. With respect to motion pictures and other content originally captured on photographic film, the mezzanine file 310 may be generated by optically scanning a high-quality master or copy of the content and storing the resulting digital information as the mezzanine file 310. The mezzanine file 310 may also include the audio portion of the content. In one example, the mezzanine file 310 may be a file encoded in the Joint Photographic Experts Group (JPEG) 2000 image compression standard used for static images. One particular example of a video-friendly version of JPEG 2000 employable in FIG. 3 is Motion JPEG 2000, which employs either lossy or lossless compression to each individual frame or image of the original audio/video content. In at least one example, Motion JPEG 2000 encoding of an original movie or other audio/video or audio/visual content results in a data rate of about 240 megabits per second (Mbits/sec) for the resulting mezzanine file 310. Other image compression standards aside from Motion JPEG 2000, providing higher or lower data rates, and either lossy or lossless data compression, may be utilized as a standard for encoding audio/video information garnered from a film or other non-electronic content medium.

The copyright holder or owner of the audio/video content may generate the mezzanine file 310 in order to provide a robust backup copy of the original filmed content. Such measures may be undertaken to prevent an unanticipated event, such as a fire at a film storage facility, from causing permanent loss of the content. Moreover, compared to film, which is difficult to store for long periods of time without severe degradation of the content, digital storage provides a virtually unlimited storage longevity for an original version and any number of backup copies with zero degradation in content quality. Further, such a file 310 may be employed directly in digital cinema theatres being developed for presenting digitally-formatted content to large numbers of viewers in a somewhat traditional theatre setting.

In another embodiment, the audio/video content may be originally created or captured as the mezzanine file 310 in a digital file format, such as, for example, Motion JPEG 2000. In other cases, the mezzanine file 310 may be directly transcoded from another original digital audio/video format with little or no loss of audio/video content integrity.

In many of the situations described above, the owner of the audio/video content may review the mezzanine file 310 before distribution to any third party, such as the audio/video processing system 300, to verify and approve the contents for overall content and quality.

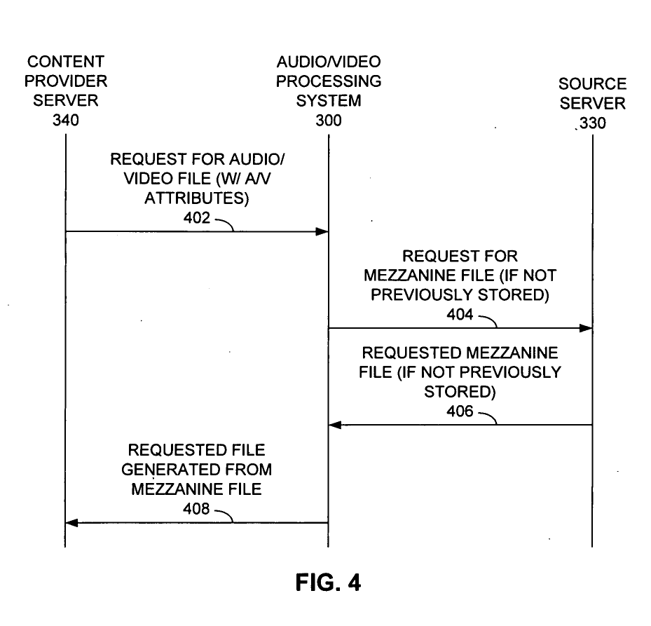

FIG. 4 presents a communication diagram illustrating one possible sequence of data transfers among a content provider server 340, a source server 330, and the audio/video processing system 300, as depicted in FIG. 3. To initiate the process of transcoding a mezzanine file 310, the audio/video processing system 300 may receive from the content provider server 340 via the communication interface 302 a set of audio/video attributes 312 indicating various characteristics of a second digital file 314 to be generated which includes the audio/video content of the mezzanine file 310 (transfer 402 of FIG. 4). The attributes 312 may include any specification or characteristic of the second digital file 314. Examples of the attributes 312 may include, but are not limited to, audio/video encoding format, video image resolution, video form factor, video image size, and audio channel encoding. In one implementation, the attributes 312 reside within an attribute file that the processing system 300 receives by way of the communication interface 302.

In one implementation, the server 340 is operated by the content provider, such as a satellite or cable communication network operator, or a third party related to the operator. Further, the attributes 312 may include or constitute a request to generate the digital file 314 containing specific audio/video content (i.e., the content of the mezzanine file 310) according to the submitted parameters 312. For example, the attributes 312 may include an identifier or other indicator specifying the particular audio/video content of interest, thus signifying the particular mezzanine file 310 to be received.

In response to receiving the attributes 312, the audio/video processing system 300 may request the required mezzanine file 310 (if not already available within the data storage 304 of the system 300) from the server 330 operated by, or on behalf of, the copyright holder or owner of the content (transfer 404 of FIG. 4). In one implementation, the request may be include a key or other security or authorization data to prevent unauthorized or unlicensed access to the associated mezzanine file 310. In response to the request, the source server 330 may then transfer the mezzanine file 310 of interest to the audio/video processing system 300 by way of the communication interface 302 (transfer 406 of FIG. 4). The content of the mezzanine file 310 also may be scrambled or otherwise encoded to prevent all but the requesting processing system 300 from accessing the mezzanine file 310.

After receiving the mezzanine file 310, the control logic 306 stores the file 310 in the data storage 304, possibly along with other previously-obtained mezzanine files 310. With both the mezzanine file 310 and the associated audio/video attributes 312, the control logic 306 of the processing system 300 may then transcode the mezzanine file 310 to generate the requested digital file 314 according to the received audio/video attributes 312. In this environment, transcoding involves translating the audio/video content as encoded in the mezzanine file 310 to another encoding scheme as specified in the audio/video attributes 312. The result of this translation is stored in the data storage 304 as the generated file 314. In one example, a mezzanine file 310 employing Motion JPEG 2000 encoding may be translated to an MPEG-2 encoded file with various audio encoding and resolution characteristics as specified in the attributes 312.

The resulting generated file 314 may be encoded in a format usable in a one or more of a variety of audio/video contents. For example, the file 314 may be useful for broadcasting the content to a television, transmitting the content to a phone, storing the content on a web server for subsequent streaming to a user, placing the content on a catalog server for video-on-demand applications accessibly via a set-top box, or preemptively downloading the content to a set-top box for possible customer viewing.

In one embodiment, the control logic 306 is capable of transcoding audio/video data encoded by any of a number of encoding schemes to data encoded according to a different scheme. To that end, the data storage 304 may include a number of transcoding modules 320, with each module 320 including an algorithm that is capable of transcoding between two files incorporating different audio/video encoding schemes when executed by the control logic 306. Thus, the control logic 306 may select the proper transcoding module 320 based on the encoding and other characteristics of the mezzanine file 310, as well as on the audio/video attributes 312, to perform the transcoding operation. Further, each transcoding module 320 may accept as input one or more of the audio/video attributes 312 to further control the resulting data generated in the digital file 314.

As part of, or immediately after, the transcoding operation, the control logic 306 may add or include other information to the generated digital file 314 that is not originally based upon or included in the associated mezzanine file 310. For example, the control logic 306 may add metadata, such as the date of transcoding, a version number of the transcoding algorithm employed, an identification of the attributes 312 used to the direct the transcoding, and many other types of identifying information. In another implementation, the control logic 306 may add index marks or similar information allowing a user to initiate “trick modes”, such as the rewinding or fast forwarding of content at various speeds selected by the user, as commonly facilitated by digital video recorders (DVRs). Such information may also include triggers for advertisements, web pages, editorial content, and other information to be presented to the user in conjunction with the audio/video content. In yet another example, the added information may include triggering information for three-dimensional (3D) liquid crystal display (LCD) shutter glasses and similar devices utilized in advanced 3D presentation systems. These examples represent just a few of the potential types of data that may be added to the generated file 314 during or after the transcoding operation.

The control logic 306 stores the file 314 generated from the transcoding of the mezzanine file 310 in the data storage 304, possibly along with previously stored generated files 314. In one implementation, each of the stored generated files 314 may include information, such as metadata, a file header, or the like, which specifies the mezzanine file 310 and the audio/video attributes 312 that were utilized to generate the file 314. As a result, a new request for generating another digital file 314 based upon the same mezzanine file 310 and attributes 312 employed to generate a previously stored file 314 may be satisfied by way of the previously stored file 314, instead of performing the transcoding operation a second time.

After the resulting audio/video file 314 has been generated, the control logic 306 may transfer the file 314 to the content provider server 340 which requested the file 314 by way of the communication interface 302 (transfer 408 of FIG. 4). If the file 314 was previously stored in the data storage 304, the control logic 304 may respond to the request for the file 314 by transmitting the file 314 to the server 340 immediately. If, instead, the desired generated file 314 does not previously exist within the data storage 304, but the mezzanine file 310 serving as the basis of the requested file 314 resides in the data storage 304, the control logic 306 may transcode the preexisting mezzanine file 310 using the received attributes 312 to generate the requested file 314, and then store and transfer the generated file 304, as described above, within a relatively short time period. However, if the control logic 306 determines that the transcoding operation may require a significant amount of time, or other transcoding operations are currently in progress, the control logic 306 may estimate the amount of time which may be required to generate the requested file 314, and transmit the estimate via the communication interface 302 to the content provider server 340.

In yet another scenario, the control logic 306 may determine in response to a request for a file 314 from the content provider server 340 that neither the requested file 314 nor the corresponding mezzanine file 310 are available in the data storage 304. As a result, the control logic 306 may inform the content provider server 340 that the mezzanine file 310 required to generate the requested file 314 must first be obtained. In one implementation, the control logic 306 may provide an estimate of the amount of time required to obtain the mezzanine file 310 from the source server 330 and transcode the file 310 to generate the requested digital file 314 containing the desired audio/video content.

Depending on the embodiment, the control logic 306 may also be configured to transfer the mezzanine file 310 by way of the communication interface 302 to the content provider server 340, presumably in response to a request from the content provider server 340. In one implementation, the request may be embodied within the audio/video attributes 312 transferred from the content provider server 340 to the processing system 300.

In one embodiment, the owner or rights-holder of the mezzanine file 310 may require the mezzanine file 310 to be deleted from the data storage 304 after a specific period of time. For example, the mezzanine file 310 transferred to the processing system 300 may include or accompany a timestamp indicating the day and time by which the file 310 must be deleted. Accordingly, the control logic 306 may monitor the current day and time, and delete the received mezzanine file 310 in accordance with the timestamp.

Moreover, the rights-holder of the mezzanine file 310 may also require deletion of any stored files 314 generated on the basis of the mezzanine file 310. An indication of that requirement may also accompany the mezzanine file 310. Thus, the control logic 306 may delete the generated files 314 in accordance with the provided timestamp. In one alternative, the rights-holder may include information with the mezzanine file 310 requiring that only those files 314 associated with certain attributes, such as minimum image resolution, minimum image size, or the like, must be deleted by the day and time indicated in the timestamp.

To facilitate security of the mezzanine file 310, the mezzanine file 310 may include security data, such as a “digital fingerprint”, which may identify or be associated with an intended recipient of the mezzanine file 310. As a result, unauthorized copies of the mezzanine file 310 or any generated file 314 based upon the mezzanine file 310 discovered may be analyzed using the included security data to determine the original authorized recipient so that the owner may take corrective action. In one implementation, source server 320 transmits the requested mezzanine file 310 with the security data already incorporated therein. Further, during the transcoding process, the control logic 306 includes the security data in the generated file 314 associated with the mezzanine file 310. In another implementation, the control logic 306 may include its own security information with each generated file 314 it stores in the data storage 304 or transfers to the content provider server 340 to further track potential unauthorized copies. In one embodiment, when employing the use of such security information, the owner of the audio/video content in the mezzanine file 310 may allow more long-term storage of copies of both mezzanine files 310 and corresponding generated files 314 due to the heightened ability to track unauthorized copies of the files 310, 314 in distribution.

While FIG. 3 depicts a single source server 330 and a single content provider server 340, any number of both types of servers 330, 340 may be communicatively coupled with the audio/video processing system 300 to perform the various functions described above. More specifically, the processing system 300 may be configured to communicate with any number of source servers 330 to request and receive mezzanine files 310 from multiple owners or rights-holders. Similarly, while a single content provider, such as a cable or satellite broadcast network operator, may be associated with the processing system 300, multiple such content providers, via one or more content provider servers 340, may request and receive content files 314 based on one or more mezzanine files 310 in other implementations.

To facilitate access by multiple content providers to the audio/video content stored in the data storage 304 of the audio/video processing system 300, the control logic 306 may be configured to maintain information regarding which of the content providers is licensed or authorized to receive which audio/video content. For example, the control logic 306 may maintain an access rights database 322 associating each stored mezzanine file 310 with one or more content providers authorized to access the file 310, and thus allowed to receive generated files 314 based upon that mezzanine file 310. In one implementation, a human operator may update the access rights database 322 based on verifiable information received from either the content owners or the content providers indicating which of the providers may access particular stored mezzanine files 310. In another alternative, either the source servers 330 or the content provider servers 340 may provide such information to the control logic 306 by way of the communication interface 302 to allow the control logic 306 to update the access rights database 322. As a result, the control logic 306 may utilize the access rights database 322 to prevent unauthorized content provider access to the mezzanine files 310 and generated files 314 stored in the data storage 304, as well as prevent the forwarding of invalid requests for content access to a source server 330.

In one embodiment, the audio/video processing system 300 may constitute a general-purpose computer system that includes any components normally associated with such a system. For example, the processing system 300 may include a user interface (not shown in FIG. 3) configured to allow a human operator to control the operation of the system 300, such as update or modify the access rights database 322 discussed above based on licensing information received from content owners and/or providers. The user interface may also be utilized to control the transcoding process and other functions of the control logic 306 described above. In another example, the processing system 300 may incorporate an electronic input interface (also not shown in FIG. 3) to allow the installation of one or more of the transcoding modules 320 discussed above. While these and other hardware and/or software components normally associated with general-purpose computer servers or systems may be included in the audio/video processing system 300 of FIG. 3, such components are not depicted therein or discussed above to simplify the foregoing discussion.

Various embodiments as described herein for transcoding audio/video content may provide several benefits. In general, the use of high-quality source files, such as mezzanine files, for the transcoding source substantially eliminates the need for physical media, such as digital tape, for that purpose. As a result, difficulties potentially associated with the use of digital tape, such as damage or degradation of the tape during transport or storage, as well as manual review of the tape by the receiving provider, are eliminated due to the exclusive use of data files that are not subject to these issues.

Also, costs associated with the generation of multiple digital tapes, which are typically generated at least once per content provider, may be reduced significantly through the generation and use of a single high-quality digital file for each item of content, from which multiple content providers may generate the one or more files required for presentation or display of the content to their corresponding users or subscribers.

While several embodiments of the invention have been discussed herein, other embodiments encompassed by the scope of the invention are possible. For example, while various implementations have been described primarily within the context of audio/video content ultimately provided to users via satellite and cable broadcast network operators, other content outlets, such as terrestrial (“over-the-air”) local television stations, mobile communications providers, and Internet web sites, may request and access audio/video content for presentation to their subscribers as set forth above. In addition, aspects of one embodiment disclosed herein may be combined with those of alternative embodiments to create further implementations of the present invention. Thus, while the present invention has been described in the context of specific embodiments, such descriptions are provided for illustration and not limitation. Accordingly, the proper scope of the present invention is delimited only by the following claims and their equivalents.

What is claimed is:

1. A method for transcoding audio/video content, the method comprising:
receiving a first digital file comprising the audio/video content;
storing the first digital file;
receiving audio/video attributes for generating a second digital file comprising the audio/video content of the first digital file;
transcoding the stored first digital file based on the audio/video attributes to generate the second digital file;
storing the second digital file; and
transferring the stored second digital file for presentation to a user.

2. The method of claim 1, further comprising:
receiving audio/video attributes for a third digital file comprising the audio/video content, wherein the audio/video attributes for generating the third digital file are different from the audio/video attributes for generating the second digital file;
transcoding the stored first digital file based on the audio/video attributes for the third digital file to generate the third digital file;
storing the third digital file; and
transferring the stored third digital file for presentation to the user.

3. The method of claim 1, further comprising:
deleting the stored first digital file based on expiration of a period of time.

4. The method of claim 3, further comprising:
deleting the stored second digital file based on the expiration of the period of time.

5. The method of claim 1, wherein:
the first digital file comprises a file generated from the audio/video content according to a lossy compression algorithm.

6. The method of claim 1, wherein:
the first digital file comprises a file generated from the audio/video content according to a lossless compression algorithm.

7. The method of claim 1, wherein:
the first digital file comprises an original version of the audio/video content.

8. The method of claim 1, wherein:
the first digital file comprises security data identifying a recipient of the audio/video content.

9. The method of claim 1, wherein:
transferring the stored second digital file for presentation to the user comprises transferring the stored second digital file over a communication network to a first content service provider.

10. The method of claim 9, wherein:
transferring the stored second digital file for presentation to the user further comprises transferring the stored second digital file over the communication network to a second broadcast service provider.

11. The method of claim 1, wherein:
the audio/video attributes for generating the second digital file comprise at least one of audio/video encoding format, video resolution, video form factor, video image size, and audio channel encoding.

12. The method of claim 1, wherein:
the audio/video attributes for generating the second digital file comprise a request to generate the second digital file.

13. The method of claim 12, further comprising:
before receiving the first digital file, transferring a request for the first digital file in response to receiving the request to generate the second digital file.

14. The method of claim 13, wherein:
the request for the first digital file comprises authorization data for accessing the first digital file.

15. The method of claim 1, further comprising:
transferring the first digital file.

16. A computer-readable medium having encoded thereon instructions executable by a processor for employing a method for transcoding audio/video content, the method comprising:
receiving a first digital file representing the audio/video content;
storing the first digital file;
receiving multiple sets of audio/video attributes for generating a plurality of second digital files representing the audio/video content;
for each of the multiple sets of audio/video attributes, transcoding the stored first digital file based of the corresponding set of audio/video attributes for one of the second digital files to generate the one of the second digital files;
storing the plurality of second digital files; and
transferring the stored second digital files for presentation to users.

17. An audio/video processing system, comprising:
a communication interface configured to transmit and receive digital files;
data storage configured to store the digital files; and
control logic configured to:
receive a first digital file of the plurality of digital files by way of the communication interface; wherein the first digital file comprises audio/video content;
store the first digital file in the data storage;
receive audio/video attributes for generating a second digital file of the plurality of digital files, wherein the second digital file comprises the audio/video content of the first digital file;
transcode the stored first digital file based on the audio/video attributes to generate the second digital file;
store the second digital file in the data storage; and
transfer the stored second digital file from the data storage by way of the communication interface to a communication device for presentation to a user.

18. The audio/video processing system of claim 17, wherein:
the control logic is further configured to transfer the stored second digital file from the data storage by way of the communication interface to a second communication device for presentation to a second user.

19. The audio/video processing system of claim 17, wherein:
the control logic is further configured to:
receive audio/video attributes for generating a third digital file representing the audio/video content of the first digital file, wherein the audio/video attributes for generating the third digital file are different from the audio/video attributes for generating the second digital file;
transcode the stored first digital file based on the audio/video attributes for generating the third digital file to generate the third digital file;
store the third digital file in the data storage; and
transfer the stored third digital file from the data storage by way of the communication interface to a second communication device for presentation to a second user.

20. The audio/video processing system of claim 17, wherein:
the communication interface comprises at least one of an Internet Protocol network interface, a Multiprotocol Label Switching network interface, an Asynchronous Transfer Mode network interface, a wide area network interface, a local area network interface, a satellite communication network interface, a cable communication network interface, and an optical communication network interface.

21. The audio/video processing system of claim 17, wherein:
the data storage comprises a plurality of transcoding modules; and
the control logic is configured to transcode the first digital file using one of the transcoding modules.

22. The audio/video processing system of claim 17, wherein:
the first digital file comprises a timestamp indicating a time by which the first digital file is to be deleted; and
the control logic is configured to delete the first digital file from the data storage in accordance with the timestamp.

23. The audio/video processing system of claim 22, wherein:
the control logic is configured to delete the second digital file from the data storage in accordance with the timestamp.

24. The audio/video processing system of claim 17, wherein:
the data storage comprises an access rights database; and
the control logic consults the access rights database to control access to the second digital file.

25. The audio/video processing system of claim 24, wherein:
the control logic consults the access rights database to control access to the first digital file.
